(19) United States
(12) Patent Application Publication
(10) Pub. No.: US 2026/0099910 A1
(43) Pub. Date: Apr. 9, 2026

(54) SYSTEM AND METHOD FOR SIGNAGE QUALITY DETECTION

(71) Applicant: Torc Robotics, Inc., Blacksburg, VA (US)

(72) Inventors: Akshay Pai Raikar, Austin, TX (US); Garrett Madsen, Austin, TX (US); William Gray Davis, Austin, TX (US); Joseph R. Fox-Rabinovitz, Austin, TX (US)

(21) Appl. No.: 18/909,757

(22) Filed: Oct. 8, 2024

(51) Int. Cl. G06T 7/00; G06V 20/56; G06V 20/58

(52) U.S. Cl. CPC G06T 7/0004; G06V 20/582; G06V 20/588; G06T 2207/30252

(57) ABSTRACT

A system for signage quality detection is provided. The system includes one or more sensors configured to detect signage around a vehicle, and a database configured to electronically store signage quality thresholds. The system includes a processing device configured to execute instructions stored in a memory to perform operations including determining a quality status of the detected signage. The quality status includes information regarding damage and/or deterioration of the detected signage. The operations include comparing the quality status of the detected signage to the signage quality thresholds. The operations include assigning a divergence value to the quality status of the detected signage as compared to the signage quality thresholds.

### TECHNICAL FIELD

The field of the disclosure relates to signage quality detection and, in particular, to a system for detecting degradation of signage with a vehicle traveling along a route.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Autonomous vehicles travel along various routes and the perception technologies are used to detect and identify signage (e.g., signs posted above-ground, signs painted on roads, or the like) along the route. Based on the signage identification, the controller technologies are used to determine which action the vehicle should take to safely continue along its route. Over time, signage degradation can occur. Local or state municipalities are generally responsible for replacing degraded signs that deviate from baseline standards set by, e.g., the Department of Transportation (DoT). However, due to the large number of signs on each road, it may be difficult for these municipalities to be aware of sign degradation.

Accordingly, there exists a need for a system and a method for signage quality detection that identifies degradation of signs along a route with an autonomous vehicle as it travels along the route. These and other needs are met by the exemplary system for signage quality detection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for signage quality detection is provided. The system includes one or more sensors associated with a vehicle. The one or more sensors are configured to detect signage around the vehicle. The system includes a database configured to electronically store signage quality thresholds. The system includes a processing device in communication with the one or more sensors and the database. The processing device is configured to execute instructions stored in a memory to perform operations including determining a quality status of the detected signage. The quality status includes information regarding damage and/or deterioration of the detected signage. The operations include comparing the quality status of the detected signage to the signage quality thresholds. The operations include assigning a divergence value to the quality status of the detected signage as compared to the signage quality thresholds.

In some embodiments, the one or more sensors can include a camera. In some embodiments, the signage can include above-ground signage (e.g., signs posted above the ground on which the vehicle is traveling). In some embodiments, the signage can include markings on a road surface (e.g., lane markings, turn arrows painted on the road, or the like). In some embodiments, the damage and/or deterioration can include physical damage to the detected signage. In some embodiments, the damage and/or deterioration can include typographical errors in the detected signage.

The vehicle can be an autonomous vehicle. The signage quality thresholds can include industry standards for acceptable and unacceptable damage and/or deterioration thresholds of signage. The unacceptable damage and/or deterioration thresholds can indicate a necessity to replace signage. In some embodiments, the signage quality thresholds can include Department of Transportation (DoT) standards for signage quality. The divergence value can be substantially zero if the quality status of the detected signage is equal or substantially equal to the signage quality thresholds. The divergence value can be greater than zero if the quality status of the detected signage is below the signage quality thresholds.

In some embodiments, the quality status of the detected signage can be determined at a first point in time. In such embodiments, the operations can include detecting the signage at a future point in time. The operations can further include determining a subsequent quality status of the detected signage at the future point in time and comparing the subsequent quality status of the detected signage to the signage quality thresholds. The operations can include comparing the subsequent quality status of the detected signage to the quality status of the detected signage at the first point in time to determine change of the damage and/or deterioration of the detected signage over time. Deterioration of signage over time can thereby be monitored and reported as needed. In some embodiments, the operations can include issuing an alert to a mission control regarding divergence of the quality status of the detected signage relative to the signage quality thresholds.

In another aspect, an exemplary computer-implemented method for signage quality detection is provided. The method includes electronically storing signage quality thresholds in a database. The method includes detecting signage around a vehicle with one or more sensors associated with the vehicle. The method includes executing instructions stored in a memory with a processing device in communication with the one or more sensors and the database to perform operations including determining a quality status of the detected signage. The quality status includes information regarding damage and/or deterioration of the detected signage. The operations include comparing the quality status of the detected signage to the signage quality thresholds. The operations include assigning a divergence value to the quality status of the detected signage as compared to the signage quality thresholds.

In some embodiments, the operations can include detecting the signage at a future point in time, determining a subsequent quality status of the detected signage at the future point in time, and comparing the subsequent quality status of the detected signage to the signage quality thresholds. In some embodiments, the operations can include comparing the subsequent quality status of the detected signage to the quality status of the detected signage at the first point in time to determine change of the damage and/or deterioration of the detected signage over time.

Various refinements exist of the features noted in relation to the above-mentioned aspects. Further features may also be incorporated in the above-mentioned aspects as well.

These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck.

FIG. 2 is a block diagram of the autonomous truck shown in FIG. 1.

FIG. 3 is a block diagram of an example computing system.

FIG. 4 is a block diagram of an exemplary system for signage quality detection.

FIG. 5 is a flowchart of a method for signage quality detection.

FIG. 6 is a flowchart for a method for signage quality detection for a traffic sign using a camera input, anomaly detection and anomaly score generation.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for signage quality detection discussed herein relies on an autonomous vehicle traveling along a route to identify when degradation of signs (whether physical or painted on the road) has occurred. The signage degradation can be determined by the vehicle based on a single detection and analysis of the sign, or can be based on two or more different points in time. The system can therefore identify and keep track of ongoing signage degradation over time. This can allow monitoring of sign quality over time to determine when replacement of the sign should be recommended before the degradation level reaches a threshold value.

The system can generally rely on industry standards to determine when deviation from such standards occurs, thereby identifying when action is needed to correct the degradation. The industry standards can be used to establish thresholds from which deviation of the existing signage is determined, and deviation from the thresholds can be used to determine when action is needed to correct the degradation. In some embodiments, a numerical deviation or divergence percentage value can be used to determine when action is needed with respect to a sign that diverges in quality from thresholds. In some embodiments, the numerical divergence percentage value can be, e.g., 25% or higher, 30% or higher, 35% or higher, 40% or higher, 45% or higher, or the like. In some embodiments, the sign types can be divided into categories, e.g., regulatory, warnings, optional, or the like, with each category having different thresholds for internally reporting their status. For example, regulatory signs can have a threshold of about 20% or more obstruction/damage, warning signs can have a threshold of about 30% or more obstruction/damage, and options signs can have a threshold of about 35% or more obstruction/damage, for action to be taken by the system.

As a further example, in some embodiments, one signage quality can be the minimum retro-reflectivity for signage. The thresholds for retro-reflectivity can be obtained from industry standards, such as DoT standards available at, e.g., https://highways.dot.gov/safety/local-rural/maintenance-signs-and-sign-supports/iii-sign-materials. Different methods for inspecting signage for adequate retro-reflectivity levels can be used. For example, the system can rely, e.g., on measuring the sign's retro-reflectivity level with a retro-reflectometer, visually comparing the sign with a test panel that has a retro-reflectivity level set at the minimum requirement, visually inspecting the sign and making a subject judgement by a trained inspector as to its adequacy, combinations thereof, or the like.

In some embodiments, the thresholds for signage quality can be based on, e.g., the Manual on Uniform Traffic Control Devices (MUTCD) available at https://mutcd.fhwa.dot.gov/kno_11th_Edition.htm, which provides an exhaustive, government mandated list of sign quality and installment measurements. A sign inspection checklist can include the following factors or characteristics associated with the sign, e.g., is the sign needed, is the sign missing, is the sign the correct one, is the sign in accordance with MUTCD, is the sign correctly positioned with respect to (i) lateral clearance, (ii) height above ground, (iii) longitudinal placement along the road, is the sign visible both day and night at the required distance, is the sign blocked by vegetation or other signs, is the sign face condition acceptable (cracking, delamination, or the like), does the sign face have fading or discoloration, does the sign face have contrast, retro-reflectivity of the sign face, has the sign face been damaged or vandalized (graffiti, bullet holes, or the like), is the sign support breaking away or yielding, are sign supports located outside the clear zone, combinations thereof, or the like.

As an example, the autonomous vehicle can detect a stop sign ahead of it on the road and can accurately detect/identify the sign as a stop sign with 70% confidence. The detected information can be compared with the existing sign characteristics and quality metrics as per DoT specifications. An assumption of a threshold of 65% for the purpose of demonstration is used. In this example, the system can flag the sign as an anomalous sign and check for other parameters, such as retro-reflectivity and discoloration per standards provided in the Federal Highway Administration (FHWA) specifications. The system's observation is added to the historic model, but an alert is not generated. If the confidence in the prediction drops to 50% or below, then the system can automatically raise an alert via mission control to indicate that remediation is needed. It should be understood that the values provided herein are not limiting and are used to merely provide an example of how the system could operate.

The system can use imaging and image processing capabilities to detect signs that deviate from specifications defined by the DoT and/or roadway authorities, particularly signs that are damaged. The system can track changes in the fidelity of information over time, and can report the identified signage issues to mission control and/or local/state authorities, providing opportunities for replacement or repair of damaged signs. This assists autonomous vehicles with clearer signage identification for guidance along its route, and further assists other drivers traveling along the route. The system can maintain a database of previously detected and identified signs along a route for purposes of keeping track of signage degradation over time. In addition, in instances where the sign is severely damaged and difficult or impossible to identify the information on the sign, such past data can be used to determine the information on the sign to ensure the autonomous vehicle continues safely on its route.

As noted herein, road signs play a critical role in ensuring the safety and efficiency of transportation systems. However, factors such as damage, wear or environmental conditions can compromise the effectiveness of signs. The system monitors road signs, identifies deviations from specifications/standards, and tracks changes in sign fidelity over time. Autonomous vehicles can travel along the same route multiple times, particularly if a fleet of autonomous vehicles is used that collaborate and collectively gather information on detected sign quality. As the autonomous vehicles travel along these routes, detection and parsing of road signs and infrastructure can be performed. In some embodiments, a neural network-based detection can be performed. For example, a neural network model can receive as input the industry standard specifications (e.g., DoT specifications) for all sign types. The detection branch of the neural network can use models that compare the detected sign characteristics with specifications provided in the database. (See, e.g., Saleh, R. et al., Predictive models for road traffic sign: Retroreflectivity status, retroreflectivity coefficient, and lifespan, International Journal of Transportation Science and Technology (2024); available at https://www.sciencedirect.com/science/article/pii/S2046043024000182). In some embodiments, the neural network model can be trained with data from damaged signs, and subsequently the model can be used to judge if input images of signs indicate damage. In some embodiments, such determination can be based on data from LIDAR and/or camera images. In some embodiments, an image processing detection can be used, e.g., capturing still images or video of signs and relying on image processing to identify sign degradation. In some embodiments, a naïve image processing approach can be used to compare a sign image against previous images of the same sign, with data including metadata indicating the location of the sign to ensure a proper match and comparison.

The data captured as representative of sign quality status can be filtered to detect damage to the sign and/or the infrastructure for the sign (e.g., posts, or the like), with the determination of degradation ascertained from road industry standards, e.g., DoT specifications. In some embodiments, repeated observations of the same sign over time can be used to detect damage and monitor progression of degradation. For example, images of road signs can be captured during multiple passes of the sign by the same or different autonomous vehicles, with the information shared between the autonomous vehicles and/or with mission control. The system can observe changes in the condition of the signage over time and assess variations in fidelity to determine when the sign has reached the degradation threshold that requires replacement. In some embodiments, the analysis over time can be used to proactively report when degradation nears (but has not reached and passed) the degradation threshold, allowing for replacement or repair before the degradation threshold has been reached.

The system can operate by continuously capturing images of road signs using onboard sensors, e.g., cameras, as the vehicle traverses a designated route. The images are processed through computer vision algorithms and/or image processing algorithms to identify signs that do not meet industry specifications. The system can log the condition of each sign and tracks changes over time, allowing for the generation of comprehensive reports and alerts. In some embodiments, this information can be stored on a database that the vehicle's autonomy system has read-write access to. The system can include a reporting mechanism that communicates detected damaged signs and/or sign infrastructure to local/state authorities. The system therefore provides a proactive approach that facilities timely maintenance and replacement of damaged signs and/or sign infrastructure, contributing to overall road safety.

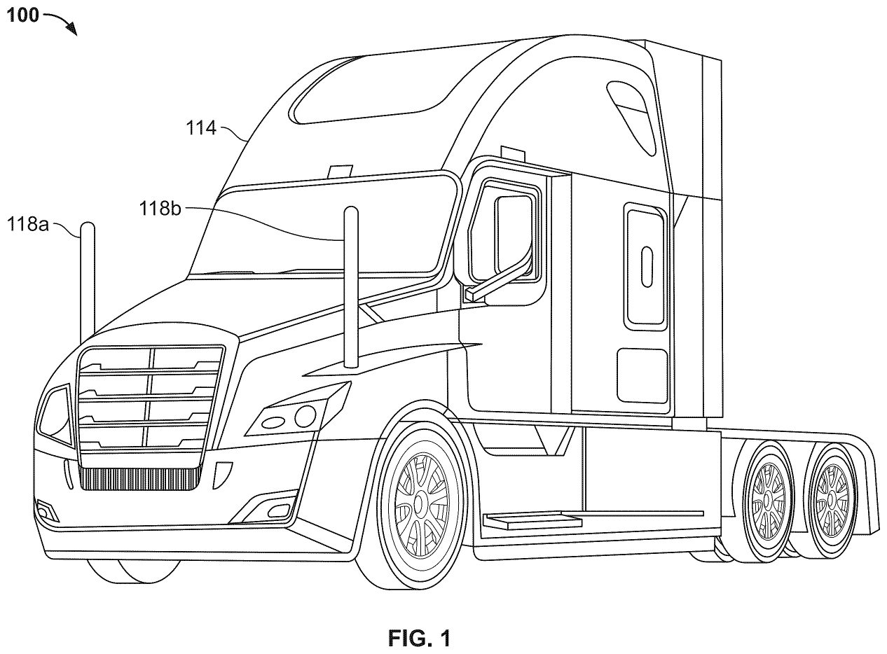

Various embodiments in the present disclosure are described with reference to FIGS. 1-6 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. For example, the vehicle 100 can include one or more antenna 118a, 118b at or near the front of the vehicle 100 with sensors having a field-of-view at the front and/or sides of the vehicle 100.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer. The environmental coverage by the sensors and/or cameras therefore provides data corresponding with the front, rear, sides and corners of the vehicle 100 and the trailer hauled by the vehicle 100.

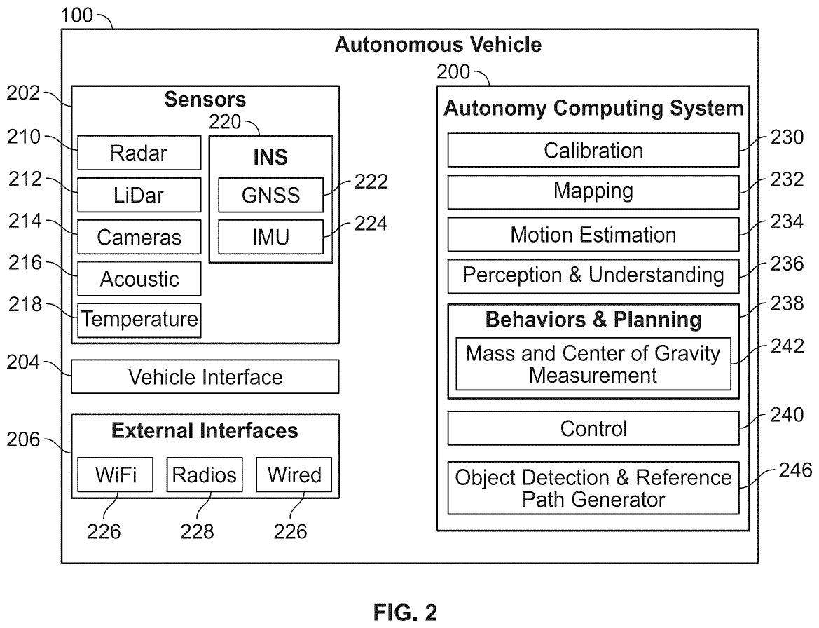

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

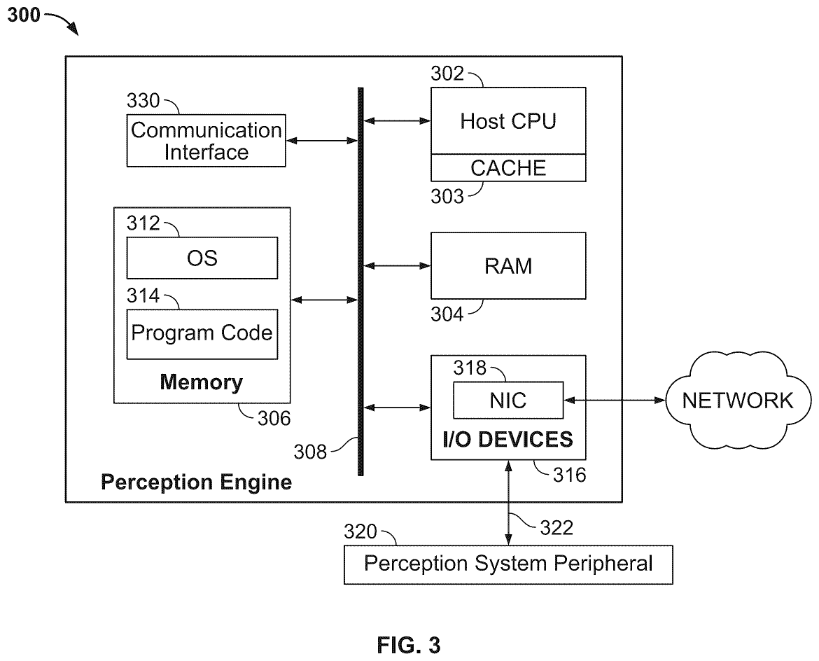

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

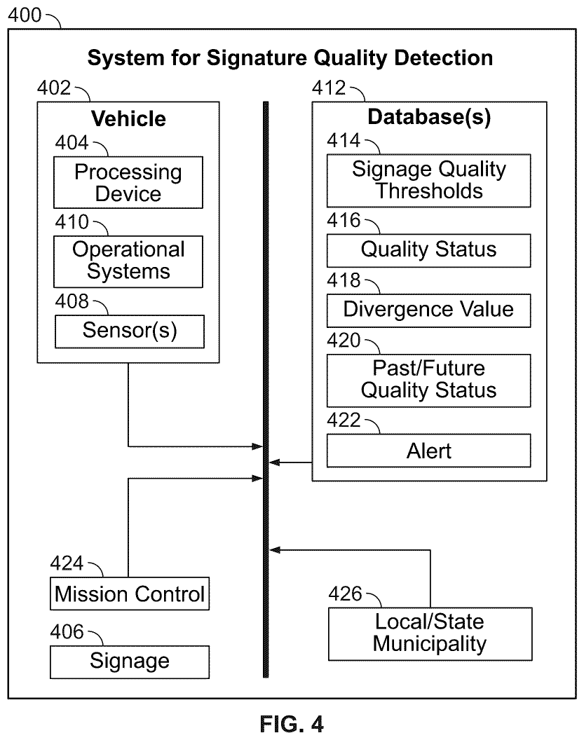

FIG. 4 is a block diagram of an exemplary system 400 for collision detection. The system 400 generally includes one or more vehicles 402 (e.g., autonomous vehicle 100). Each vehicle 402 includes a processing device 404 (e.g., computing system 200, computing system 300, or the like) configured to receive and process data for detecting signage 406 quality as the vehicle 402 travels along a route. The data associated with the signage 406 is received by the processing device 404 from one or more sensors 408 (e.g., sensors 202). In some embodiments, the sensors 408 can include, e.g., cameras or any other image/video capturing devices, configured to capture images and/or video of signage 406 passed by the vehicle 402 as it travels along a route. The signage 406 can include signs posted above ground and markings on the road surface itself, such as turn arrows or lane separators. In addition to determining the signage 406 quality and potential degradation, the processing device 404 analyzes the signage 406 to determine whether action is needed by one or more operational systems 410 of the vehicle 402 to control movement of the vehicle 402 along the route.

The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. The database 412 can include signage quality thresholds 414 used by the system 400 to determine if the detected signage 406 is degraded to the point of needed replacement or maintenance. In some embodiments, the signage quality thresholds 414 can be based on standards established by road authorities, such as the Department of Transportation (DoT).

In some embodiments, the signage quality thresholds 414 can be based on standards established by local or state authorities.

The signage quality thresholds 414 can include information on various types of damage associated with the signage 406, such as, e.g., physical damage, physical deterioration, or the like. Thresholds 414 and type of damage can be provided based on industry standards discussed herein, including but not limited to the Repair and Replacement of Sign Panels discussed in U.S. Department of Transportation Federal Highway Administration, available at https://highways.dot.gov/safety/local-rural/guide-street-and-highway-maintenance-personnel/ii-repair-and-replacement-sign. In some embodiments, the signage quality thresholds 414 can also include information on damage in the form of typographical errors, and the system 400 can be used to detect and identify such typographical errors. The thresholds 414 provide a standard for identifying signage 406 that may have acceptable damage or deterioration, as compared to unacceptable damage or deterioration that necessitates replacement/maintenance.

As the vehicle 402 travels along the route, the sensors 408 detect and capture images of the signage 406. The processing device 404 can analyze the captured images from the sensors 408 using computer vision and/or image processing algorithms to determine the quality status 416 of the signage 406. The analysis can determine various types of damage or degradation, including but not limited to, e.g., broken areas of the sign or infrastructure, worn areas of the sign (such as letters, paint, reflective material, or the like), damage induced by others (such as spray paint), legibility, typographical errors, combinations thereof, or the like.

In addition to detecting the type of damage, the processing device 404 determines the amount of damage detected. For example, if only a small corner of a sign is broken or missing, the processing device 404 can identify the damage while noting that the damage does not affect the main content of the sign. However, if half of the sign has been broken or is missing, the processing device 404 can identify the damage and notes the significant amount of missing information. Once the signage 406 and any damage assessment has been made, the processing device 404 compares the quality status 416 of the signage 406 to the thresholds 414 to determine the deviation from the thresholds 414. The deviation determination generates a divergence value 418—a numerical value—indicative of the deviation of the quality status 416 as compared to the thresholds 414. If the divergence value 418 is zero or substantially zero, this indicates that the quality status 416 is substantially equal to the thresholds 414 and no action for maintenance/replacement is needed. If the divergence value 418 is greater than zero, this indicates that the quality status 416 is below the thresholds 414 and a maintenance/replacement action is needed. In some embodiments, if the divergence value 418 is less than 40%, the system can make an internal reference that the sign may require attention in the future, but no alert is issued. In some embodiments, if the divergence value 418 is 40% or less from the thresholds 414, the system can issue an alert.

In some embodiments, in addition to immediate signage 406 detection and analysis, the system 400 can be used to monitor degradation of signage 406 over time. In such embodiments, the images captured by the sensors 408 can be stored for different points in time, e.g., past/future quality status 420, and the processing device 404 can determine the progression of degradation of the signage 406. To accurately identify and store data associated with the signage 406, the system 400 can capture the global positioning system (GPS) coordinates for the signage 406, ensuring accuracy in identification over time. For each point in time, the system 400 generates a divergence value 418 and can monitor the change in divergence value 418 to determine if replacement/maintenance action is needed. This allows the system 400 to determine if the quality status 416 is within the threshold 414 values or ranges, e.g., if immediate action needed, or proactively determine when the quality status 416 is such that remediation will be needed soon. In some embodiments, the images captured over time can be used to assist the vehicle 402 control operations with the systems 410 if the signage 406 degradation at the future point in time is to such a level that, e.g., text on the signage 406 cannot be detected. In such instances, the past images can be used to determine the information on the signage 406 such that the vehicle 402 can effectively determine operational actions.

If the divergence value 418 reaches a predetermined value and indicates that remediation of the signage 406 damage/deterioration is needed, the system 400 can issue an alert 422 to mission control 424 and/or local/state municipalities 426 to indicate that action is needed. The system 400 can either issue the alert proactively to put the municipalities 426 on notice of ongoing degradation that will need action in the near future, or can issue an alert only when the degradation has already reached a level that necessitates replacement/maintenance. The system 400 therefore improves overall signage 406 quality on roadways for both autonomous vehicles 402 and other vehicles traveling along the routes.

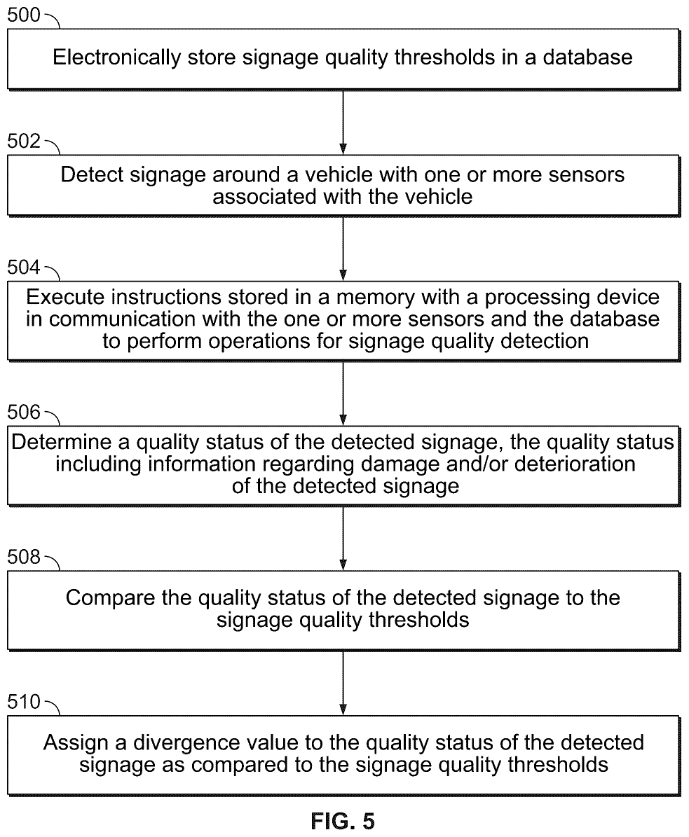

FIG. 5 is a flowchart of a method of signage quality detection by the exemplary system 400 discussed herein. In particular, FIG. 5 represents a method for determining signage quality relative to a predetermined threshold to determine if replacement/maintenance of the signage is needed. At 500, signage quality thresholds can be electronically stored in a database. At 502, signage around a vehicle is detected with one or more sensors associated with the vehicle. At 504, instructions stored in a memory are executed with a processing device in communication with the one or more sensors and the database to perform operations for signage quality detection. At 506, a quality status of the detected signage is determined. The quality status includes information regarding damage and/or determination of the detected signage. At 508, the quality status of the detected signage is compared to the signage quality thresholds. At 510, a divergence value is assigned to the quality status of the detected signage as compared to the signage quality thresholds to determine deviation of the quality status from the thresholds. Based on the divergence value, the system determines if replacement/maintenance of the signage is needed.

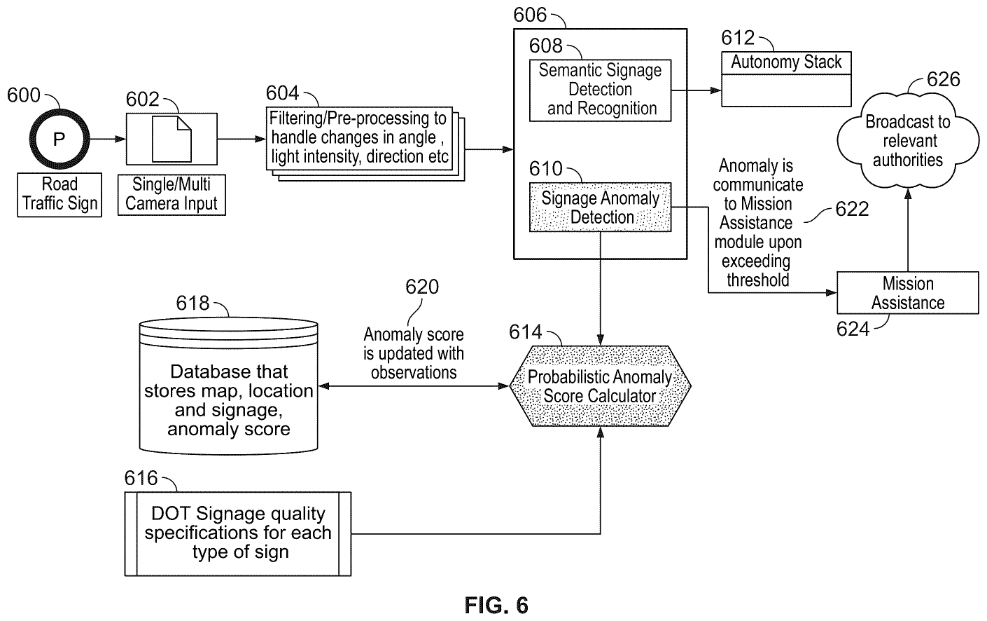

FIG. 6 is a flowchart of a method of signage quality detection by the exemplary system 400 discussed herein. In particular, FIG. 6 represents a method for determining a quality of a traffic sign using a camera input, anomaly detection and anomaly score generation, and applies the general method of FIG. 5 At 600, signage (such as road traffic signs and signs painted on the road) are passed by the vehicle. At 602, the system receives as input single or multi camera images of the signage. At 604, filtering and/or pre-processing of the images is performed to handle changes in angle, light intensity, direction, or the like, to improve overall analysis of the contents of the images. The filtered/pre-processed data is transmitted to an image processing unit 606. The unit 606 can include a semantic signage detection and recognition module 608 and a signage anomaly detection module 610. The module 608 can analyze the input image data and outputs data to an autonomy stack 612. In some embodiments, the module 608 can detect the sign and its contents, module 610 can be the anomaly detection model where the system analyzes the output of the module 610, and compares it with the database and raises alerts while also updating the internal sign database. In some embodiments, 612 an be the rest of the autonomous driving software that potentially uses the output of the sign detection model.

At 614, the module 610 communicates with a probabilistic anomaly score calculator (e.g., a divergence value generator), which determines the extent or percentage of divergence of the sign quality relative to industry thresholds/standards. The anomaly score calculator can receive as input industry standard data 616, e.g., DoT signage quality specifications for each type of sign. The anomaly score calculator can be in communication with a database 618 storing information associated with the detected signage, e.g., map, location, signage information, anomaly/divergence value score, or the like. For example, the database 612 can store previously generated anomaly or divergence values, and at 620 the system updates the anomaly or divergence value score with the most current observations of the same signage. In some embodiments, the anomaly/divergence value can be calculated using a difference from ideal (e.g., threshold or baseline standards), including edges and all icons. For text-based sigs, the system can determine the readability of each letter.

At 622, if the anomaly or divergence value score is above a threshold value, the anomaly is communicated by the system to mission control 624. Mission control 624 can, in turn, transmit an alert to the appropriate authorities for replacement/maintenance of the signage (at 626). In some embodiments, mission control 624 can transmit an alert to other vehicles to reroute the vehicles based on missing signage information, for example, or to alert vehicles of damaged information that can be supplemented with previous data to allow for continued operation of the autonomous vehicles. The system therefore provides a safety mechanism for maintaining signage on roadways.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for signage quality detection, comprising:
one or more sensors associated with a vehicle, the one or more sensors configured to detect signage around the vehicle;
a database configured to electronically store signage quality thresholds; and
a processing device in communication with the one or more sensors and the database, wherein the processing device is configured to execute instructions stored in a memory to perform operations comprising:
determining a quality status of the detected signage, the quality status including information regarding damage and/or deterioration of the detected signage;
comparing the quality status of the detected signage to the signage quality thresholds; and
assigning a divergence value to the quality status of the detected signage as compared to the signage quality thresholds.

2. The system of claim 1, wherein the one or more sensors include a camera.

3. The system of claim 1, wherein the signage includes above-ground signage.

4. The system of claim 1, wherein the signage includes markings on a road surface.

5. The system of claim 1, wherein the damage and/or deterioration includes physical damage to the detected signage.

6. The system of claim 1, wherein the damage and/or deterioration includes typographical errors in the detected signage.

7. The system of claim 1, wherein the vehicle is an autonomous vehicle.

8. The system of claim 1, wherein the signage quality thresholds includes industry standards for acceptable and unacceptable damage and/or deterioration thresholds of signage.

9. The system of claim 8, wherein the unacceptable damage and/or deterioration thresholds indicate a necessity to replace signage.

10. The system of claim 1, wherein the signage quality thresholds includes Department of Transportation standards for signage quality.

11. The system of claim 1, wherein the divergence value is zero if the quality status of the detected signage is equal to the signage quality thresholds.

12. The system of claim 1, wherein the divergence value is greater than zero if the quality status of the detected signage is below the signage quality thresholds.

13. The system of claim 1, wherein the quality status of the detected signage is determined at a first point in time.

14. The system of claim 13, wherein the operations comprise detecting the signage at a future point in time.

15. The system of claim 14, wherein the operations comprise determining a subsequent quality status of the detected signage at the future point in time, and comparing the subsequent quality status of the detected signage to the signage quality thresholds.

16. The system of claim 15, wherein the operations comprise comparing the subsequent quality status of the detected signage to the quality status of the detected signage at the first point in time to determine change of the damage and/or deterioration of the detected signage over time.

17. The system of claim 1, wherein the operations comprise issuing an alert to a mission control regarding divergence of the quality status of the detected signage relative to the signage quality thresholds.

18. A computer-implemented method for signage quality detection, comprising:
electronically storing signage quality thresholds in a database;
detecting signage around a vehicle with one or more sensors associated with the vehicle; and
executing instructions stored in a memory with a processing device in communication with the one or more sensors and the database to perform operations comprising:
determining a quality status of the detected signage, the quality status including information regarding damage and/or deterioration of the detected signage;
comparing the quality status of the detected signage to the signage quality thresholds; and
assigning a divergence value to the quality status of the detected signage as compared to the signage quality thresholds.

19. The computer-implemented method of claim 18, wherein the operations comprise detecting the signage at a future point in time, determining a subsequent quality status of the detected signage at the future point in time, and comparing the subsequent quality status of the detected signage to the signage quality thresholds.

20. The computer-implemented method of claim 19, wherein the operations comprise comparing the subsequent quality status of the detected signage to the quality status of the detected signage at the first point in time to determine change of the damage and/or deterioration of the detected signage over time.
